(19) United States
(12) Patent Application Publication
(10) Pub. No.: US 2006/0000173 A1
(43) Pub. Date: Jan. 5, 2006

(54) Composite structures having the appearance of knotty wood and methods of making such structures

(76) Inventor: Brian D. Edstrom, Chula Vista, CA (US)

Correspondence Address: KILPATRICK STOCKTON LLP - 49942, 1001 WEST FOURTH STREET, WINSTON-SALEM, NC, 27101, US

(21) Appl. No.: 10/871,234

(22) Filed: Jun. 18, 2004

(51) Int. Cl. B44F 7/00

(52) U.S. Cl. 52/313

(57) ABSTRACT

Disclosed are composite structures having the appearance of knotty wood and methods for making such composite structures. Also described is a skin sheet imitating a knotty wood appearance. The skin sheet may be applied to a supporting framework to make a composite door or other type of building structure having the rustic look of natural knotty wood.

### FIELD OF INVENTION

The present invention is related to articles of composite construction finished to resemble real wood having a rustic, knotty appearance.

### BACKGROUND

Real wood doors have a pleasing appearance and a substantial and solid feel. Many species of wood having a desirable appearance are expensive and require significant labor and time for production of finished articles. Also, while the appearance of natural wood is aesthetically pleasing, wood is susceptible to damage caused by long-term exposure to humid or dry air, weather, and insect pests. Thus, frequent and often costly maintenance can be required to prevent the deterioration of finished wood that is exposed to outdoor environments.

One type of wood that is particularly popular in some markets is wood that has a rustic, knotty appearance. This rustic, knotty look is characteristic of Alder trees, which are found primarily in the northwestern United States. Due to inconsistencies in the wood grain that result from knots, however, this type of wood can be prone to splitting or cracking, especially in dry climates. For example, a door-sized wood panel may lose almost half of its moisture content, thereby shrinking as much as ⅜^{th} of an inch, when exposed to the hot and dry climate typical of the desert southwest. Attempts have been made to overcome the splitting and cracking that is inherent to knotty wood. Unfortunately, alterations made to reduce splitting of wood along the grain can often induce tension in the wood grain elsewhere, thereby causing an increase in cracking of the wood at the edges of the panel, or warping of the wood. Although sealants may be used to reduce drying of the wood, such sealants tend to fail over time, especially at the joints between panels.

Composite structures having the appearance of real wood have been developed. Such composite structures are generally more resistant to weathering and/or physical stress than natural wood. For example, composites of wood fiber and a polymer resin pressed as thin layers are used to make skin sheet structures used in the manufacture of doors (i.e., door skins). Alternatively, glass-fiber reinforced polyester resins may also be used to manufacture door and window units. Still, composites made of fiberglass and other synthetic materials, while often exhibiting increased resistance to the elements, may not be as aesthetically pleasing as wood-based composites.

Many early attempts at production of composite wood substitutes were not successful in emulating a surface texture characteristic of the grain of wood. Often, adding such detail requires substantial time and a highly skilled labor force, thus escalating the cost of composite substitutes. Commonly owned U.S. Pat. No. 6,485,800 addresses these drawbacks and describes a method for making articles of composite structure having the appearance of grained wood. As described in U.S. Pat. No. 6,485,800, such composite articles provide an attractive appearance closely resembling natural wood, while avoiding some of the disadvantages of natural wood.

What is further needed, however, is a method to produce composite structures that have the beneficial attributes associated with synthetic polymer resins, but that provide the unique look characteristic of knotty wood, such as knotty Alder and other types of highly grained and/or patterned wood, and related methods and products.

### SUMMARY

Embodiments of the present invention provide composite structures having the appearance of knotty wood and methods of making such composite structures. An example embodiment of the present invention comprises a composite structure comprising an outer surface imitating a knotty wood appearance, wherein the composite structure comprises at least one polymer resin and the outer surface is molded to replicate a wood grain surface comprising at least one knot.

Another example embodiment of the present invention comprises a composite structure comprising a skin sheet imitating a knotty wood appearance applied to a support structure, wherein the skin sheet comprises an outer surface molded to replicate a wood grain surface comprising at least one knot. In one embodiment, the skin sheet may be applied to a frame for a door such that the composite structure comprises a door.

The present invention also comprises methods for making composite structures having a knotty wood grain appearance. In one embodiment, the method comprises making a mold comprising a surface that imitates a wood grain surface with at least one knot, and applying a polymer resin to the surface of the mold to form a composite structure of predetermined shape on the surface of the mold such that the composite structure comprises a surface molded to replicate the shape of a wood grain surface comprising at least one knot. In an example embodiment, the method may further comprise fashioning at least one template comprising a wooden panel having a wood grain surface with at least one knot, and using the template to manufacture a mold such that at least one surface of the mold comprises substantially a mirror image of the wood grain of the template. Also, the composite structure may be attached to a support structure to provide an outer surface molded to replicate a wood grain surface comprising at least one knot. In an embodiment, the composite structure may comprise a skin sheet.

There are numerous advantages associated with embodiments of the composite structures of the present invention. Due to the unique patterning of the skin sheets used for each composite, products according to the present invention may avoid having a repetitive, stamped appearance. For example, composite doors of the present invention may be almost indistinguishable from a true wooden door in appearance.

Also, the composite structures of the present invention may be individualized to provide products that each have a unique look. For example, the knots and/or the wood grain pattern on the surface of a composite structure may be enhanced using airbrush modification of the grain and/or knot pattern. Also, the knots and/or the wood grain pattern on the surface of a composite structure may be enhanced by modifying the staining of the grain and/or knot pattern.

Also, embodiments of the composite structures of the present invention may be made so as to not only look like real wood, but to feel and sound like wood. For example, when used for manufacture of a door, the composite structures of the present invention may be made so as to feel and sound like a solid wood door.

Although designed to look and feel like natural wood, the composites of the present invention may exhibit the superior performance characteristic of the polymer resins used to make the composites. The composite structures of the present invention may be formulated to exhibit sufficient flexibility to resist cracking and/or breaking as for example, when attached to an underlying frame or support Also, the composite structures of the present invention may be formulated to have an impact resistance that is superior to natural wood. In addition, the composite structures of the present invention may display reduced shrinking and swelling resulting from loss and gain of moisture, respectively, as compared to natural wood having a knotty grain.

Yet another advantage associated with certain embodiments of the present invention is that although designed to look and feel like rustic, knotty wood, the composite structures do not split and/or crack like real wood structures made using wood from knotty trees. Thus, the composite structures of the present invention may be well suited to harsh environments, such as salt water areas, hot desert climates, or wet, rainy areas.

The present invention may be better understood by reference to the description and figures that follow. It is to be understood that the invention is not limited in its application to the specific details as set forth in the following description, figures, and claims, but is capable of other embodiments and of being practiced or carried out in various ways.

### BRIEF DESCRIPTION OF THE DRAWINGS

FIG. 1 illustrates a front view of a composite door having a surface appearance of a knotty wood grain in accordance with an embodiment of the present invention.

FIG. 2 illustrates a partial view of the surface of a composite door having the appearance of a knotty wood grain and corresponding to the area enclosed by the dashed lines in FIG. 1 in accordance with an embodiment of the present invention.

FIG. 3 illustrates an overview of methods for making composite structures having a surface appearance of a knotty wood grain in accordance with alternate embodiments of the present invention.

FIG. 4 illustrates methods of making composite structures, such as doors or other building parts, having a surface appearance of a knotty wood grain in accordance with alternate embodiments of the present invention.

FIG. 5 illustrates a partial perspective cross-sectional view of the surface of a mold used to prepare a composite door having the appearance of a knotty wood grain in accordance with an embodiment of the present invention.

FIG. 6 illustrates a partial perspective cross section of a composite door having a surface appearance of a knotty wood grain in accordance with an embodiment of the present invention.

### DETAILED DESCRIPTION

Embodiments of the present invention comprise composite structures having the appearance of knotty wood, and methods of making such structures. One embodiment of the present invention comprises a composite structure comprising an outer surface imitating a knotty wood appearance, wherein the composite structure comprises at least one polymer resin and the outer surface is molded to replicate a wood grain surface comprising at least one knot.

The composites may each be individually formulated to have a unique look. In one embodiment, at least one knot on the surface of the composite structure of the present invention may be modified from its original appearance by coloring the area of the composite surface comprising the knot. For example, the knot may be modified by coloring the area comprising the knot using an air brush. The surface of the composite may be colored using stains or other colorants known in the art. In an embodiment, the surface of the composite structure is colored with at least one pigmented stain.

Yet another embodiment of the present invention comprises a composite structure comprising a skin sheet imitating a knotty wood appearance applied to a support structure, wherein the skin sheet comprises an outer surface molded to replicate a wood grain surface comprising at least one knot.

The skin sheet may be made of a variety of materials so long as the sheet structure maintains its shape and surface characteristics when it is used as part of the composite structure. For example, the skin sheet may be applied to a frame for a door, such that the composite structure comprises a door. Also in an embodiment, the door may comprise a foam core.

The skin sheet may comprise a single layer or the skin sheet structure may comprise multiple layers. In one embodiment, the skin sheet may comprise an outer layer of cured gel coat material. The skin sheet may comprise a pigment for coloration. Thus, the skin sheet may comprise a layer of pigmented gel coat material either as the outer layer or as a second layer. For example, where the skin sheet comprises a multi-layer sheet, the outer gel coat layer may be substantially transparent, and the skin sheet may comprise a pigmented subsurface layer positioned adjacent to the outer layer. It has been found that the combination of a transparent gel coat layer positioned adjacent to a pigmented layer may provide for a structure that replicates the combination of lignin and clear cell structure typical of natural wood, thereby imitating a high resolution wood grain on the skin sheet surface.

Alternatively, and/or additionally, the skin sheet may comprise a fiber-reinforced resin. In an embodiment, the fiber-reinforced resin may comprise a structural support layer that is positioned adjacent to the support structure. Thus, in one embodiment, the skin sheet may comprise an outer, transparent gel coat layer, a pigmented subsurface layer positioned adjacent to the outer gel coat layer, and a structural support layer positioned adjacent to the pigmented subsurface layer.

A variety of polymer-based or synthetic resins known in the art of composite manufacture may be employed in the composite structures present invention. In one embodiment, the polymer resin may comprise a UV-cured polyester resin. Or, the polymer resin may comprise polyurethane. In one embodiment, a blend of syntactic polyurethanes may be used. Other resins known in the art may be used, such as wood-based composites using formaldehyde-based resins, isocyanate-based resins, and the like. Also suitable for the composite structures of the present invention are resins comprising polystyrene, polyvinyl chloride (“PVC”), PVC with wood powder, polypropylene, polypropylene with glass fiber, or epoxy resins.

A fiber or other type of filler (e.g., calcium carbonate or the like) may be included in the polymer resin. Also, fiber-reinforced resins made using reinforced reaction injection molding (“RRIM”) or long fiber injection (“LFI”) technology, such as described in Publication Nos. 2002/0160204 and 2004/0034113, both of which are incorporated by reference herein in their entireties, may be used for the composite structures and methods of making as described herein. For skin sheet structures, the fiber-reinforced resin may also comprise a sheet molding compound (SMC) polyester-based resin (optionally including other polymers such as polystyrene), or modifications thereof, such as described in U.S. Pat. Nos. Re 36,240 and 6,487,824, also incorporated by reference in their entireties herein.

The composites may each be individually formulated to have a unique look. In one embodiment, at least one knot on the surface of the composite structure of the present invention may be modified from its original appearance by coloring the area of the composite surface comprising the knot. For example, the knot may be modified by coloring the area comprising the knot using an air brush. The surface of the composite may be colored using stains or other colorants known in the art. In an embodiment, the surface of the composite structure is colored with at least one pigmented stain.

The present invention also comprises methods for making composite structures imitating a knotty wood appearance. In one embodiment, the method may comprise the steps of making a mold comprising a surface imitating a wood grain surface with at least one knot, and applying a polymer resin to the surface of the mold to form a composite structure of predetermined shape on the surface of the mold such that the composite structure comprises a surface molded to replicate the shape of a wood grain surface comprising at least one knot. The method may further comprise the step of making a template substantially the same shape as the surface to be replicated, and using the template to make the mold. Thus, in an embodiment, the method includes identifying and/or fashioning at least one template comprising a wood grain surface with at least one knot, and making the mold from the template such that one surface of the mold comprises substantially a mirror image of the template surface having a wood grain surface with at least one knot.

The composite structure may comprise a variety of shapes. For example, in an embodiment, the composite structure may comprise a skin sheet comprising an outer surface molded to replicate a wood grain surface comprising at least one knot. In other embodiments the composite structure may comprise a thin-layer composite for a panel, such as might be used for a door or wall. Or, the composite structure may comprise a casing for a door frame or a window frame such as brick molds and/or door jambs.

A variety of polymer-based or synthetic resins known in the art of composite manufacture may be employed using the methods of present invention. In one embodiment, the polymer resin may comprise a UV-cured polyester resin. Or, the polymer resin may comprise polyurethane. In one embodiment, a blend of syntactic polyurethanes may be used. Other resins known in the art may be used, such as wood-based composites using formaldehyde-based resins, isocyanate-based resins, and the like. Also suitable for the composite structures of the present invention are resins comprising polystyrene, polyvinyl chloride (“PVC”), PVC with wood powder, polypropylene, polypropylene with glass fiber, or epoxy resins. Also, a fiber or other type of filler (e.g., calcium carbonate or the like) may be included in the polymer resin.

In one embodiment, the skin sheet made by a method of the present invention may comprise a single layer. Alternatively, the skin sheet structure may comprise multiple layers. In an embodiment, the skin sheet may comprise an outer layer of cured gel coat material. In an embodiment, the skin sheet may comprise a pigment for coloration. Thus, the skin sheet may comprise a pigmented layer either as the outer layer or as a second layer. For example, where the skin sheet comprises a multi-layer sheet, the outer gel coat layer may be substantially transparent, and the skin sheet may comprise a pigmented subsurface layer positioned adjacent to the outer layer. Alternatively, and/or additionally, the skin sheet may comprise a fiber-reinforced resin. In one example embodiment, the fiber-reinforced resin may comprise a structural support layer that is positioned adjacent to the support structure. Thus, in one embodiment, the skin sheet may comprise an outer, transparent gel coat layer, a pigmented subsurface layer positioned adjacent to the outer gel coat layer, and a structural support layer positioned adjacent to the pigmented subsurface layer.

The skin sheet may be assembled on the mold. For example, in one embodiment, the method may include the steps of applying a pigmented subsurface layer to a substantially transparent gel coat layer that has been cured on the mold surface, and then curing the subsurface layer to generate a skin sheet having a first layer of cured gel coat adjacent to the mold and a second pigmented subsurface layer. If a structural support layer is desired, the method may then further include applying a structural support layer comprising a fiber-reinforced resin to the subsurface layer and curing the structural support layer to generate a cured skin sheet having an first layer of gel coat adjacent to the mold, a second pigmented subsurface layer, and a third structural support layer. In this way, a multi-layer skin sheet comprising a substantially transparent outer gel coat layer, a pigmented subsurface layer, and a fiber-reinforced structural layer may be assembled on the mold.

Using the methods of the present invention, the composites may each be individually formulated to have a unique look. The surface of the composite may be colored using stains or other colorants known in the art. In an embodiment, the surface of the composite structure is colored with at least one pigmented stain. Also, at least one knot on the surface of the composite structure of the present invention may be modified from its original appearance by coloring the area of the composite surface comprising the knot. In an embodiment, the knot may be modified in appearance by coloring the area comprising the knot using an air brush.

The composite structure of predetermined shape may be applied to an underlying structural support. Thus, in one example embodiment of the present invention, the method may comprise applying the composite structure of predetermined shape to a support structure to provide an outer surface molded to replicate a wood grain surface comprising at least one knot. The support structure may comprise a variety of forms depending upon the application. In an embodiment, a portion of the support structure may comprise an inner core made of a material distinct from the material used to make the exterior of the support structure. Thus, the method may further include the step of creating a cavity defined by the composite structure and the support structure and filling the cavity with a self-foaming resin. In this way, building structures such as, but not limited to, composite doors, wall panels, door frame parts, window frame parts, and the like may be made.

Embodiments of the present invention may provide methods for the manufacture of composite doors having a rustic knotty look. For example, in one embodiment, the present invention comprises a method for making a composite door imitating a knotty wood appearance comprising: (a) fashioning at least one template comprising a wooden panel having a wood grain surface with at least one knot; (b) making a mold using the template such that one surface of the mold comprises substantially a mirror image of the wood grain of the template; (c) forming a skin sheet on the surface of the mold by: (i) applying a polymer resin comprising a transparent gel coat material to the surface of the mold and curing the resin on the surface of the mold; (ii) applying a pigmented subsurface layer to the cured gel coat layer and curing the subsurface layer to generate a skin sheet having a first layer of transparent gel coat and a second pigmented subsurface layer; (iii) applying a structural support layer to the cured pigmented subsurface layer and curing the structural support layer to generate a skin sheet having a first layer of transparent gel coat, a second pigmented subsurface layer, and a third structural support layer, wherein the first layer comprises a surface molded to replicate a wood grain surface comprising at least one knot; and (d) adhering two of the skin sheets to a frame such that the surface of the skin sheet that was adjacent to the mold is positioned as the outer surface to comprise a surface molded to replicate the shape of a wood grain surface comprising at least one knot.

Embodiments of the present invention include composite doors having a knotty wood appearance. For example, the present invention may comprise a composite door comprising a skin sheet imitating a knotty wood appearance applied to a frame support, wherein the skin sheet comprises an outer surface molded to replicate a wood grain surface comprising at least one knot. In one embodiment, at least one knot on the surface of the skin sheet is modified from its original appearance by coloring an area of the skin sheet comprising the knot. In an example embodiment, the knot may be modified by coloring the area comprising the knot using an air brush.

Where the composite is used for the manufacture of a door, the support structure may comprise a frame having two rails and two stiles as is known in the art of door manufacture. The method may also comprise applying adhesive material to the skin sheet for adhering the skin sheet to a the frame. Also, the composite structure may comprise a support molding for emplacing a panel (such as a window) in the door as is known in the art. In an embodiment, an adhesive is used to attached the skin sheets to the molding for the emplaced panel.

Doors and other Building Structures Comprising Knotty Wood Grain Surface

Thus, the present invention provides composite structures that have the appearance of natural knotty wood. Knots comprise regions of concentric grain in wood such as may be formed by the intersection of a tree branch with the trunk of the tree. As used herein, through knots comprise knots that are substantially tangential to the grain of the wood and thus, appear as regions of relatively wide grain that is somewhat curved or oval in shape. In contrast, spike knots comprise knots that have been cut substantially perpendicular to the circumference of the knot and thus, appear as substantially concentric circular patterns in the grain of the wood.

A variety of articles may be manufactured using the methods of the present invention. The composite structure of the present invention may comprise a door having a surface molded to replicate a wood grain surface comprising at least one knot. In another embodiment, the composite structure may comprise a panel used for a door or wall. Alternatively, the composite structure may comprise a casing for a door frame or a window frame such as, but not limited to, brick molds and/or door jambs. Alternatively, the composites of the present invention may be used to make furniture products having a rustic knotty wood grain appearance. Thus, the composites of the present invention may be used in the manufacture of furniture such as cabinets, tables, benches, hot tubs, and the like.

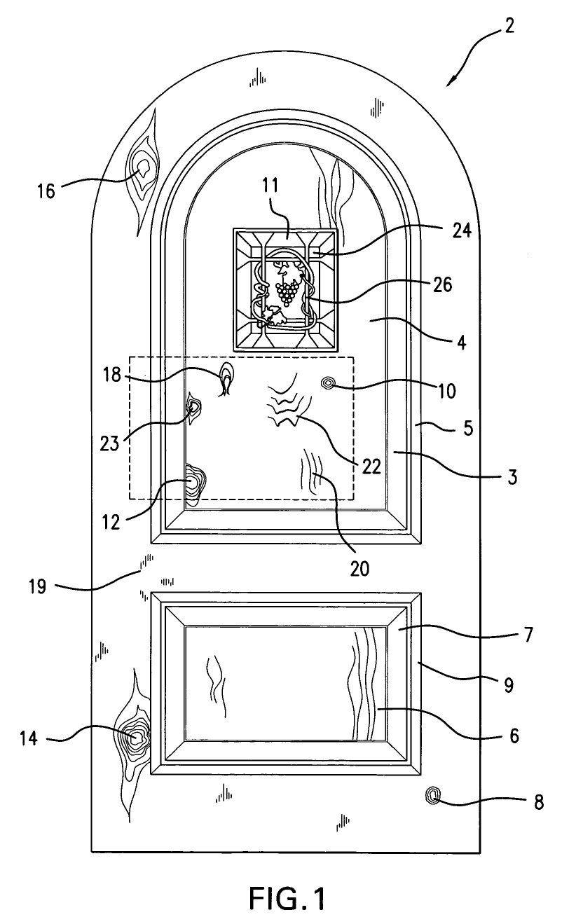

As indicated, the present invention may comprise a variety of products and methods. FIGS. 1-6 illustrate an application of the present invention to the manufacture of a composite structure, such as a door, having a knotty wood grain. FIG. 1 shows an embodiment of a composite structure of the present invention comprising a composite door 2 having the look of a knotty Alder door. Shown in the embodiment depicted in FIG. 1 is a rounded door 2 having upper panel 4 accentuated by molding 3 and 5, and lower panel 6 accentuated by molding 7 and 9. In an embodiment, door 2 may comprise a supportive molding 11 used for emplacement of a window or other type of accessory panel 24 in the door. As shown in FIG. 1, the door may be further accessorized with a decorative grating 26, or the like.

FIG. 1 illustrates the knotty appearance of the composite structures of the present invention. Thus, door 2 may comprise knots and other patterns in the grain that give the composite a unique, rustic appearance. The knots may be selected to have a variety of shapes and coloring. Thus, some of the knots may be comprised of tight, concentric circles such as knots 8 and 10. Others may comprise larger patterns having less regular rings that are differentiated in color and spread throughout the grain such as knots 12, 14 and 16. Also, check knots 23, comprising depressed areas relative to the surrounding surface, may be included. Still other areas of the door may comprise areas of defined grain that resemble wood cut tangential to a knot such as patterns 18, 20 and 22. Also shown are regions of the wood that correspond to relatively smooth, hard wood having minimal grain 19.

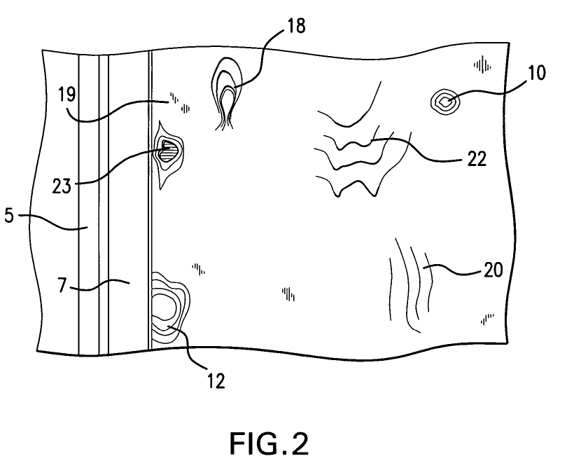

FIG. 2 shows an enlargement of a portion of a door comprising a surface imitating a knotty wood appearance such as the region of a door shown by the dotted lines in FIG. 1. Shown is the molding 5 and 7 used to define upper panel 4. Also shown are a variety of knot and grain patterns of the composite structures of the present invention. Thus, grain patterns emulating small 10 and large 12 spike knots that are cut perpendicular to the grain of the circumference of the knot (i.e., spike knots) may be seen. Also shown are patterns typical of grain cut tangential to a knot (i.e., through knots) as for example regions 18, 20 and 22. Again, regions of the wood 19 that correspond to relatively smooth, hard wood with a minimal grain are also depicted on the surface of the door.

Embodiments of the present invention may be formulated in part using existing procedures for composite manufacture. Thus, in an embodiment, the composite structures of the present invention may be prepared using a layering method similar to that described in commonly owned U.S. Pat. No. 6,485,800 to Littschwager et al., filed Feb. 7, 2001, and entitled “Articles of Composite Structure Having Appearance of Wood.” The disclosure of U.S. Pat. No. 6,485,800 is hereby incorporated by reference in its entirety herein.

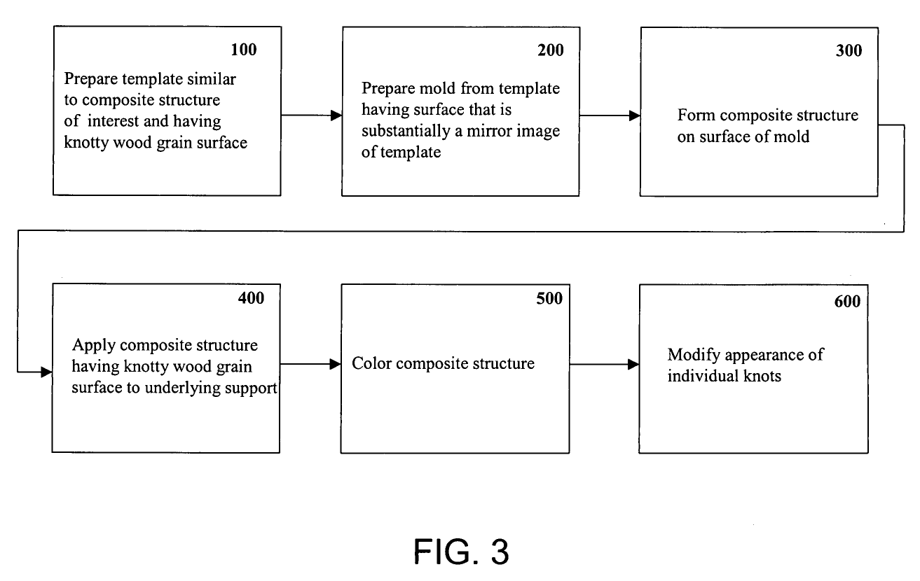

An overview of methods that may be used to prepare composite structures having the appearance of knotty wood is provided in FIG. 3. In one embodiment, the first step in making the composite structures of the present invention is the preparation of a wooden structure having an appearance that is substantially similar to the appearance desired of the composite 100 (FIG. 3). In an embodiment, this wood structure is used as a template or “plug” for fashioning a mold. For example, where the final product is a door, a door made of a knotty wood may be used as the wood plug or template. Or where the final product is a panel, a panel made of a knotty wood may be used as the wood plug or template. Or where the final product is a frame for a door or window, a frame part (e.g., brickmold, jamb) made of a knotty wood may be used as the wood plug or template. Next, the template may be used to fashion a mold that comprises a surface that is substantially the mirror image of at least one surface of the template 200. The mold may then be used to fashion a composite structure having a surface that replicates the knotty wood grain of the template 300. In some cases, the composite structure may be applied to an underlying support structure 400. Alternatively, the composite structure may not require an underlying support structure. The composite structure may next be colored (or stained) in a manner that gives the composite the coloration of real wood 500. Finally, the method may comprise the step of indivualizing the knots, as for example coloring individual knots by airbrushing 600.

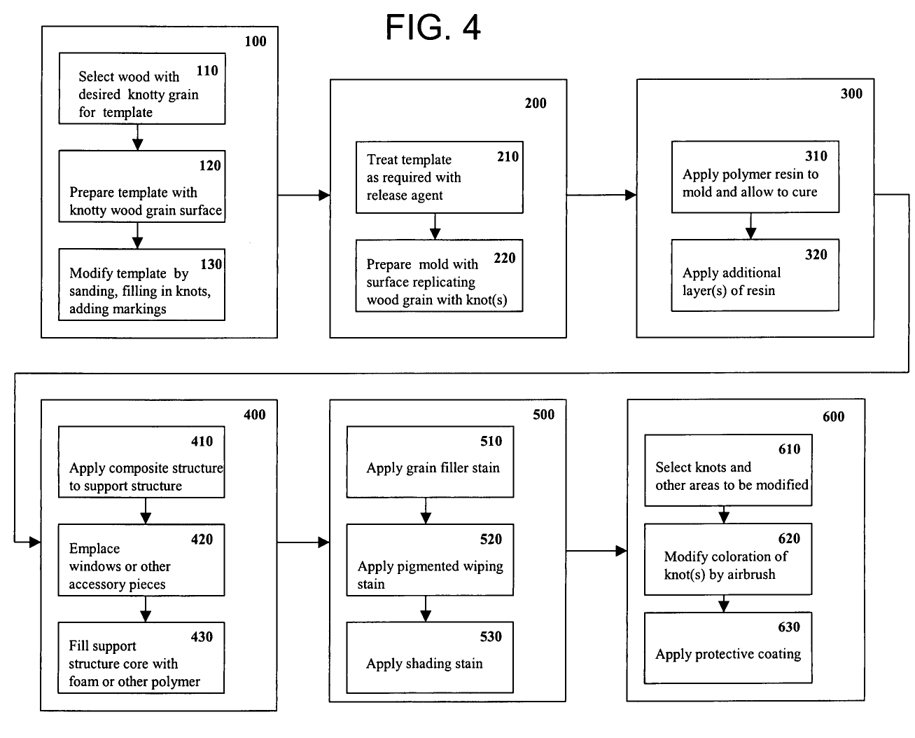

FIG. 4 shows an embodiment of the method shown in FIG. 3. As shown in FIG. 4, in one embodiment, the production of the template may include the step of selecting a particular type of wood or grain to be reproduced 1 10. In an embodiment, a door or a door panel comprising at least one face that is made of a knotty wood may be fashioned as the template or wood plug 120. The template may be made of any type of wood having the grain appearance desired. In an embodiment, the wood used for the template may comprise Alder wood. In some cases, however, other types of wood may be preferred, even when the final product is designed to emulate Alder wood. For example, some species such as Alder may vary in color throughout the grain or the rings of a knot, but have minimal difference in the grain density for the different rings. Such wood will display a highly patterned appearance when the real wood is used, but may not replicate the pattern well when the wood is used as a mold. Other species, such as Walnut, may display variations in density throughout the grain or the rings of a knot. Wood displaying a variation in density throughout the pattern of the grain can provide for a higher resolution mold since the variations in density may be captured by the mold surface. Thus, in an embodiment, the wood plug or template for composite doors made to emulate Alder wood may comprise walnut wood. In another embodiment, red oak may be used as the template or plug. For example, a red oak template may be used to cast skin sheets that resemble white oak. Similarly, additional species such as, but not limited to, teak, birch, or big-leaf maple may be used to emulate wood species that may be difficult to cast from a mold such as cherry or hard rock maple.

At the step of preparing the wood plug template, it can be important to use wood that has a particular type of knot structure. Thus, in an embodiment, the wood used for the template comprises a flat grain material that comprises predominantly through knots as opposed to spike knots. In an embodiment, wood comprising predominantly through knots, but including both through knots and spike knots, is selected for the template.

In an embodiment, knots that are intact and substantially without voids may be preferred. Knots having a substantial void may appear as a region comprising concentric layers of wood grain that is recessed below the surface of the wood; these types of knots are known to those in the art as check knots. In some cases, however, wood containing a certain proportion of check knots may be used to impart a realistic look to the final composite product.

The wood plug template may be treated to enhance the wood grain pattern 130 (FIG. 4). For example, the grain surface may be enhanced by carefully sanding and wire brushing the wood surfaces. Also, some of the check knots may be filled to bring the level of the knot closer to the surface. For example, in some cases, clay may be used to fill in voids that may be present in a knot in the template or plug. In this way, the knot is used as part of the skin sheet, but may not be as deep as in the original template. In an embodiment, the clay is pressed into the knot (or other void) on the surface of the template and formed to the desired shape. In an embodiment, check knots having different depths ranging from about 0.01 mm up to about 20 mm may be included. Alternatively, check knots having different depths ranging from about 0.05 mm up to about 8 mm may be included.

There are additional techniques that may be used to add unique markings to the template 130. For example, holes and other natural wood characteristics such as worm holes, seasoning checks, abraded areas, small splits, dents, chips and the like may be added to the template surface to give the composite a more rustic appearance. Such markings may also be added to the individual thin-layer composite.

From the wood plug template, a mold or die may be made of material capable of reproducing fine detail 200 (FIGS. 3 and 4). In an embodiment, the surface of the wood plug template may be treated to prevent it from sticking to the material of which the mold is to be made 210. For example, the wood plug template may be sprayed with a mold release compound, such a platinum or silicone petroleum-based mold release compound. The mold may be made from a conventional silicone rubber mold material using conventional mold preparation techniques 220. For example, in an embodiment, the mold is made as described in commonly owned U.S. Pat. No. 6,485,800. For example, an RTV silicone rubber compound available from Diversified Materials (La Mesa, Calif.) may be suitable for making the mold. The mold should be manufactured to faithfully reproduce the minute surface irregularities of the wood grain of the model.

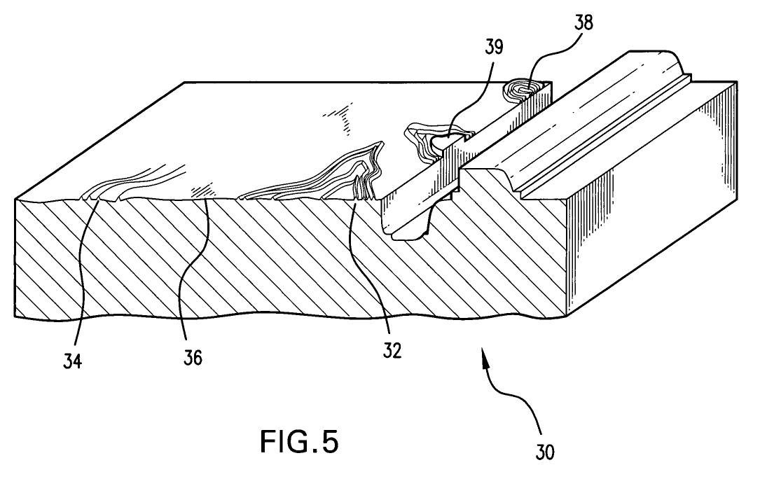

An embodiment of a mold or die 30 used to make the composites of the present invention is shown in FIG. 5. Thus, as shown in FIG. 5, the mold surface is designed to include irregularities 32 and 34 as projections corresponding to through knots and heavy grain, respectively. Also, the mold surface may include relatively smooth portions 36 corresponding to the smooth portions of the grain of the wood. Also in an embodiment, the mold comprises surface markings corresponding to spike knots 38 and check knots 39. Thus, the projections and/or depressions in the mold surface are intended to reproduce grain patterns such as those in shown in FIGS. 1 and 2, and the smoother parts of the mold surface are intended to reproduce areas of lighter grain.

The wooden plug template may comprise a front and back side, both of which may be used to make molds for manufacture of the composite structures of the present invention. By mixing and matching mold surfaces, the resulting products have a unique look characteristic of real wood doors, rather than the stamped look of a pre-molded composite.

At this point, a composite structure may be prepared on the mold surface 300 (FIGS. 3 and 4). In an embodiment, a skin sheet comprising multiple layers is made. In an embodiment, preparation of the skin sheet may be as described in commonly owned U.S. Pat. No. 6,485,800. Alternatively, other methods of preparing single layer or multi-layer thin-layer composites as known in the art may be employed.

In an example embodiment, to make a skin sheet, a first layer corresponding to what will be the outermost layer of the skin sheet may be applied to the mold surface 310 (FIG. 4). For the skin sheet or skin sheet outer layer, thickness ranging from about 0.0005 inches (0.0127 mm) to about 0.4 inches (10 mm) maybe used. Alternatively, a thickness from about 0.002 inches (0.0508 mm) to about 0.2 inches (5 mm) may be used. In some cases ranges outside these limits may be preferred, depending upon the specific application. In an embodiment, as for example where the skin sheet is used to manufacture doors, the first (outer) layer may comprise an average thickness of about 0.003 inches (0.076 mm) to about 0.02 inches (0.5 mm).

In an embodiment, the outermost layer may be made of a resin-based gel coat material. In an embodiment, the outer layer may comprise some type of coloration or pigmentation. Alternatively, the outer layer of gel coat may be substantially colorless. For example, the outer layer may comprise a clear UV-cured polyester resin such as those described in U.S. Pat. No. 6,485,800. Alternatively, other clear gel coat resins known in the art may be employed as the outer layer. Such gel coat resins may be produced by AOC (Collierville, Tenn.), and Ashland Specialty Chemical Company (Dublin, Ohio), and are distributed by suppliers such as Diversified Materials Company (La Mesa, Calif.), Interplastic Corporation (St. Paul, Minn.), or North American Composites (Lino Lakes, Minn.). For a single layer skin sheet, a polyurethane or epoxy resin may be preferred. Other resins known in the art, such as but not limited to, formaldehyde-based resins, isocyanate-based resins, wood-based composites, polystyrene resins, polyvinyl chloride (“PVC”) resins, PVC with wood powder, polypropylene resins, and polypropylene resin with glass fiber, may also be used for some applications. Such resins may be commercially available off the shelf, or specifically formulated as required.

The resin used to form the skin sheet (or skin sheet outer layer) may be applied to the mold surface to the required thickness in uncured form by conventional pour or spray application and cured in place to form a surface adjacent to the mold that replicates, as a mirror image, the grain patterns present on the mold surface. The other surface of the skin sheet (i.e., the side of the skin sheet opposite the mold) may be allowed to harden to form a relatively smooth surface or may be otherwise modified as required.

In an embodiment, a second subsurface layer of pigmented gel coat material may be applied to the first outer layer while the skin sheet is still on the mold 320 (FIG. 4). The pigmented gel coat may then be cured in place (i.e., on top of the first skin sheet layer). The pigmented subsurface resin may comprise resins standard in the art, such as, but not limited to a polyester-based gel coat material. Such resins may be commercially available off the shelf, or specifically formulated as required. Because the resin comprises a pigment, a catalyst such as methylethyl ketone peroxide (MEKP), or others known in the art, may be used to facilitate UV curing.

In an embodiment, the pigmented subsurface layer comprises a pigmentation similar in color to the lightest color present in the species of wood intended to be imitated by the skin sheet being prepared. The pigmented coat may be prepared to have a thickness so as to be substantially opaque and to appear solidly colored when viewed through the outer layer. In an embodiment, the pigmented subsurface layer may range from about 0.0005 inches (0.0127 mm) to about 0.4 inches (10 mm) thick, or from about 0.002 inches (0.0508 mm) to about 0.2 inches (5 mm) thick.

In one embodiment, additional layers may be used for the skin sheet 320. For example, in an embodiment, a third structural support layer may be applied to the skin sheet. The structural support layer may comprise a fiber-reinforced resin. Thus, the structural support layer may comprise an inner layer that provides mechanical strength and support for both the outer gel coat layer and the pigmented subsurface gel coat layer. Alternatively, the skin sheet may be formulated as a single layer of fiber-reinforced resin.

In an embodiment, the structural support layer may comprise a conventional resin with embedded glass fibers. The fiber may be glass fibers, mineral fibers, or natural fibers such as wood, flax, jute, or sisal fibers, and/or synthetic fibers, such as polyamide fibers, polyester fibers, carbon fibers or polyurethane fibers. In one embodiment, a mat of glass fiber strands such as a 1.5 inch continuous filament glass fiber mat impregnated with an ultraviolet curing polyester resin layer (Diversified Materials Company, La Mesa, Calif.), may be applied to adhere closely to the exposed inner surface of the subsurface layer and gently rolled to remove any air bubbles.

Where the skin sheet is formulated as a multi-layer laminate, the method may include steps to remove any pockets of air that may form between the laminate layers. For example, an adhesive putty may be used in small spaces and corners to avoid air pockets between the subsurface gel coat layer and the glass-reinforced resin of the structural support layer.

The fiber-reinforced structural support layer may be cured in place while the skin sheet is still on the mold. The thickness of the structural support layer may depend on the particular application. In alternative embodiments, the structural support layer may range from about 0.001 inches (0.0254 mm) to about 0.4 inches (10 mm), or from about 0.02 inches (0.508 mm) to about 0.2 inches (5 mm), or from about 0.05 inches (1.27 mm) to about 0.125 inches (3,175 mm) thick may be used.

In an embodiment, the overall thickness of the skin sheet may range from about 0.02 inches (0.51 mm) to about 0.5 inches (12.7 mm). For example, when used for the manufacture of a composite door, the overall thickness for the total skin sheet may have a thickness ranging from about 0.1 to 0.2 inch (2.54 to 5.08 mm) thick. In one embodiment, the skin sheet used for a composite door is about 0.125 inches (3.175 mm) thick. Other types of articles may be prepared having alternate ranges of overall thickness.

A primer or other colorant may be included in the composite structures of the present invention to facilitate subsequent painting of the structure. For example, a primer may be included in the outer coat of a multi-layer laminated skin sheet. Or, a composite structure made for use as a window frame or door frame part may comprise a pigment as part of the composite. In yet another embodiment, a primer may be applied to the composite after the part is made.

At this point, and referring again to FIGS. 3 and 4, the composite may be attached to an underlying support structure 400. For example, the skin sheet may be applied to an underlying support structure such as a frame for a door 410. An adhesive may be applied to the skin sheet for attaching the skin sheet to the underlying support structure. For example, a methacrylate adhesive (ITW Plexus, Danvers Mass.) may be applied to appropriate portions of the exposed surface of the skin sheet as it sits on the mold. Two separate molds each supporting such skin sheets may then be placed in properly registered locations to adhere to a frame that will be used to form the structure of interest. In an embodiment, each mold is adequately supported and pressed toward the frame structure.

The frame for a door may comprise a pair of upright stiles, and bottom and top horizontal top rails, where the stiles and rails form the rectangular peripheral shape of the door. In an embodiment, an interior structural portion of the frame parts may be of a multi-layered laminated wood material. Also in an embodiment, an outer surface of the frame may comprise solid real wood, as for example, real wood of the species imitated by the composite skin sheets. In this way, if the skin sheets on both faces of the door are trimmed to be flush with the frame, the frame may form the outer boundary for the edge of the door.

Once the two skin sheets (i.e., either multi-layered or single layered) are assembled on the frame, the skin sheets together with the frame structure may define a cavity into which an appropriate quantity of a self-foaming resin mixture can be pumped 430 (FIG. 4). During this step, the molds should be supported adequately to resist the force generated as the foam material expands to form a foam core. In an embodiment, the foam material used for the core fills the cavity and adheres to the exposed surfaces of the frame and skin sheets. In an embodiment, the foam may comprise an open cell polyurethane foam with a density in the range of about 10 lbs/ft³ (160.2 kg/cm³) to about 30 lbs/ft³ (480.6 kg/cm³). In alternate embodiments, the foam may comprise a open cell polyurethane foam with a density in the range of about 12 lbs/ft³ (192.2 kg/cm³) to about 18 lbs/ft³ (288.4 kg/cm³), or from about 12 lbs/ft³ (192.2 kg/cm³) to about 15 lbs/ft³ (240.3 kg/cm³). For example, foam comprising the appropriate density may be purchased from Hydroseal Polymers, Inc., (Riverside, Calif.), AOC (Collierville, Tenn.), and Diversified Materials Company (La Mesa, Calif.). Foam materials of similar composition and varying density may be used depending on the composite structure being made. In one example embodiment, the foam core is slightly less dense than real wood and forms a substantially rigid microcellular foam core.

Embodiments of the composite doors of the present invention may look, sound, and perform like real wood. In an embodiment, doors made using the framed composite skin sheets of the present invention and having a polyurethane foam core are within 20% of the weight of a real wooden door having the same dimensions. In another embodiment, the composite doors of the present invention are within 5 to 10% of the weight of a real wooden door having the same dimensions. Also in an embodiment, the open cell polyurethane core sounds substantially the same as real wood.

After the foam core has solidified, the molds may be removed from the skin sheets. The skin sheets can then be trimmed to the proper finished dimension to be flush with the stiles and rails of the frame.

In some cases, the composite structure may comprise an inner panel, such as a window 420 (FIG. 4). In this embodiment, a supportive molding (or casting) 11 (FIG. 1) may be used. Such supportive moldings may comprise a means of being secured to the underlying support structure and positioned in an aperture in the skin sheet. In an embodiment, the panel 24 may be inserted into the molding 11, and then the entire assembly is clamped in place in the underlying door frame and/or core. Once the panel has been positioned, the molding may be secured to the skin sheet using an adhesive.

Once the composite structure has been assembled, the entire surface of the composite structure may be provided with a coloration resembling natural wood 500 (FIG. 4). For example, the finish may comprise a stain, or multiple stains, such as a wood stain applied in a conventional manner to fill the grain pores and to cover and color the portions representing the hard part of the wood grain. In an embodiment, the finish may include a clear and transparent outer coating.

As when staining a real wood surface, the stain may be applied as multiple coats or as a single coat. In an embodiment, the first coat may comprise a grain filler 510 (FIG. 4). In an embodiment, the grain filler may comprise a heavily pigmented wiping stain. The grain filler may be used to at least partially fill in the open pore portions of the skin sheet, thus coloring those portions of the surface of the composite structure depicting a heavy grain. Depending upon the coloration required, the grain filler may be bought off the shelf, or may be custom-made from suppliers known in the art (e.g., Sherwin-Williams Co., Cleveland, Ohio).

Next, a second pigmented wiping stain may be applied on top of the grain filler 520 (FIG. 4). In an embodiment, the second wiping stain is not as heavily pigmented as the grain filler stain. Instead, the second wiping stain may be used to provide an even tonality throughout the wood for any subsequent shading or stain layers. In this way, there is a substantial flexibility in how the composite may be colored. In an embodiment about 70% to 80% of the color is added by the second wiping stain. In an embodiment, more than one type of wiping stain may be used for this coloration step. Again, depending upon the coloration required, the pigmented wiping stain applied at this step may be bought off the shelf or may be custom-made from suppliers known in the art (e.g., Sherwin-Williams Co., Cleveland, Ohio).

Thereafter, a layer of shading stain may be applied to the surface of the composite structure 530 (FIG. 4). As is known in the art, the shading stain may also comprise a pigmented wiping stain. The shading stain may function to modify the color(s) provided by the first grain filler stain and any additional wiping stain(s) already applied to the skin sheet. In an embodiment, the shading stain provides the remainder of the color (i.e., the portion of the color not provided by previous staining steps) to the composite structure being made. Although the shading stain may comprise a wiping stain, in an embodiment, the shading stain may be sprayed onto the surface of the composite. Again, depending upon the coloration required, the shading stain may be bought off the shelf or may be custom-made from suppliers known in the art (e.g., Sherwin-Williams Co., Cleveland, Ohio).

At this point, further detailing of the surface may be performed 600. In an embodiment, some of the knots and grain patterns on the surface of the skin sheet may be accentuated while the coloring of other knots may be reduced. For example, a knot on the skin sheet layer may be colored to better blend with a surrounding area of flat grain. Or, the knot may be further accentuated so that the grain defining the ring structure is even more defined. For example, in one embodiment, the center of the knot may be lightened and the surrounding rings darkened to emulate the look of a typical knot.

One technique that may be used to modify the appearance of specific knots comprises airbrushing the outer layer of the skin sheet (or any composite structure) made to have a surface imitating a knotty wood grain. In this technique, various stains may be applied to the skin sheet using an airbrush and selected templates to accentuate or lessen the color and/or size of particular knots. Thus, using a template having distinct circular and/or oval patterns, the knots and surrounding rings may be darkened or lightened to provide uniqueness of shading for each skin sheet. Generally, the addition or augmentation of knots is done in places where a true knot is found in the wood, as adding a knot in at a flat grain portion of the wood can make the wood grain appear artificial.

The step of accentuating and/or modifying the knot structure of the composite skin may comprise first choosing which knots will be highlighted 610 (FIG. 4). In an embodiment, about 5% to about 90% of the knots and areas of heavy grain present on the surface of the skin sheet may modified in some manner. In another embodiment, about 10% to 50% of the knots and areas of heavy grain present on the surface of the skin sheet may be modified in some manner. For example, in a skin sheet for a door, about ten or twelve out of the twenty or more knots on the skin sheet may be selected to be modified in some manner. This allows for numerous knot configurations in the final composite structure while requiring use of only one mold.

Next, a pattern for coloring a particular knot may be chosen from a selection of templates of various size and shapes. Using an airbrush, the knot may then shaded to the desired shape and color 620. This method provides for a considerable latitude and creativity in modifying the look of a specific composite. Thus, by selecting different groups of knots to be highlighted for each skin sheet, a variety of composite skin sheets, each having a unique, individual character may be created using skin sheets made from a single side of a single mold.

Additional techniques may be used at this point to add unique markings to the skin sheet. For example, holes and other natural wood characteristics such as worm holes, seasoning checks, abraded areas, small splits, dents, chips and the like may be added to the template surface to give the composite a more rustic appearance.

Once the stain has been applied in the usual fashion and the detailing is complete, a durable protective finish coating such as lacquer, varnish, or a synthetic resin finish may be applied in much the same manner as in finishing wood, to protectively coat the stain 630. In an embodiment, an acrylic urethane sealer coating and/or a clear acrylic finish coat may be applied, as for example, Polane® coating, Resin Clear F63 VXC 17987 Top Coat (Sherwin-Williams Co.).

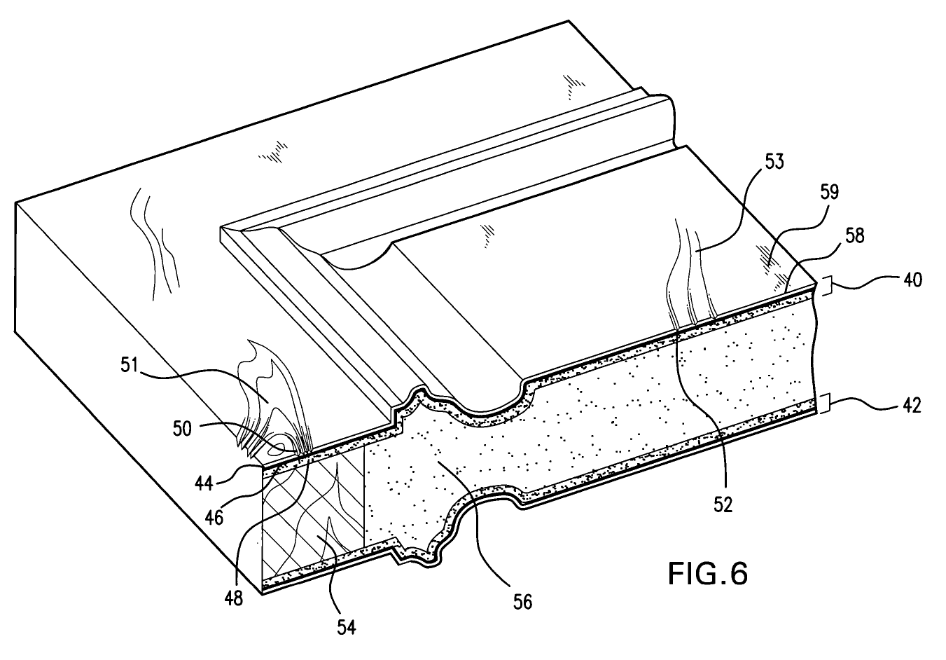

FIG. 6 shows a partial cross-sectional view of a door comprising the composite skin sheets of the present invention. As shown in FIG. 6, the resulting door may include a pair of skin sheets 40 and 42, a structural frame 54, and a foam core 56. In an embodiment, each of the skin sheets comprises a clear gel coat as the outer layer 44, a second, pigmented coat 46 as the middle layer, and a subsurface fiber-reinforced layer 48 as the inner layer. Also in an embodiment, the outer layer 44 comprises a pattern similar to a knotty wood door, wherein the pattern of the outer layer 44 comprises substantially the mirror image of a mold made from a wooden door used as a template. Each assembly comprising two skin sheets, a frame, and a foam core may be adhesively unified into a rigid structure. Thus, the composite doors of the present invention comprise a weight and a feeling of solidity similar to that of a real wooden door of comparable size.

For example, as described above, skin sheets 40 and 42 may each be attached to opposite faces of an underlying frame 54 by a suitable adhesive. Between the skin sheets 40 and 42 and within the area surrounded by the frame structure 54 is a cavity that is filled with synthetic foam to form a core 56. In an embodiment, the material used for the foam core 56 is a relatively dense microcellular polyurethane foam. Also in an embodiment, the foam material of the core 56 adheres to the interior surfaces of the skin sheets 40 and 42 and the stiles and rails of frame structure 54, and thus helps to bond the component structures of the door to each other.

As partially illustrated in FIG. 6, the outer surface of the skin sheet has the appearance of real wood. Wood grain structures 50 closely resembling through knots 51 in real wood are apparent. Also, grain structures 52 resembling transverse knots or other regions heavy grain 53 are found in outer layer 44. Portions 58 that simulate relatively smooth areas of the wood 59 are also found in outer layer 44. The skin sheet 42 of the other side of the door is of substantially similar appearance, but with a unique grain and knotty wood patterning that imitates an opposite side of a door of the same real wood species.

As used herein, the singular forms “a”, “an” and “the” include plural references unless the context clearly dictates otherwise. It will be understood that each of the elements described above, or two or more together, may also find utility in applications different from the types described. While the invention has been illustrated and described as composite structures having the appearance of knotty wood and methods of making such composites, it is not intended to be limited to the details shown, since various modifications and substitutions can be made without departing in any way from the spirit of the present invention. As such, further modifications and equivalents of the invention disclosed herein may occur to persons skilled in the art using no more than routine experimentation, and all such modifications and equivalents are believed to be within the spirit and scope of the invention as described herein.

That which is claimed is:

1. A composite structure comprising an outer surface imitating a knotty wood appearance, wherein the composite structure comprises at least one polymer resin and the outer surface is molded to replicate a wood grain surface comprising at least one knot.

2. The composite structure of claim 1, wherein at least one knot on the surface of the composite structure is modified from its original appearance by coloring an area of the composite structure comprising the knot.

3. The composite structure of claim 2, wherein the knot is modified by coloring the area comprising the knot using an air brush.

4. A composite structure comprising a skin sheet imitating a knotty wood appearance applied to a support structure, wherein the skin sheet comprises an outer surface molded to replicate a wood grain surface comprising at least one knot.

5. The composite structure of claim 4, wherein the skin sheet comprises multiple layers.

6. The composite structure of claim 4, wherein the skin sheet comprises a gel coat material as the outer layer.

7. The composite structure of claim 6, wherein the gel coat material is substantially transparent.

8. The composite structure of claim 4, wherein the skin sheet comprises a pigmented layer.

9. The composite structure of claim 4, wherein the skin sheet comprises a fiber-reinforced polymer resin.

10. The composite structure of claim 9, wherein the fiber-reinforced polymer resin comprises a structural support layer positioned adjacent to the support structure.

11. The composite structure of claim 4, wherein the skin sheet comprises an outer, transparent gel coat layer, a pigmented subsurface layer positioned adjacent to the outer gel coat layer, and a structural support layer positioned adjacent to the pigmented subsurface layer.

12. The composite structure of claim 4, wherein the skin sheet comprises a polyurethane resin.

13. The composite structure of claim 4, wherein at least one knot on the surface of the skin sheet is modified from its original appearance by coloring an area of the skin sheet comprising the knot.

14. The composite structure of claim 13, wherein the knot is modified by coloring the area comprising the knot using an air brush.

15. The composite structure of claim 4, wherein the support structure comprises a frame for a door.

16. The composite structure of claim 15, wherein the support structure comprises a foam core.

17. A method for making a composite structure imitating a knotty wood appearance comprising:
making a mold comprising a surface that substantially replicates a wood grain surface with at least one knot; and
applying a polymer resin to the surface of the mold to form a composite structure of predetermined shape on the surface of the mold such that the composite structure comprises a surface molded to replicate the shape of a wood grain surface comprising at least one knot.

18. The method of claim 17, further comprising identifying at least one template comprising a wood grain surface with at least one knot, and making the mold from the template such that one surface of the mold comprises substantially a mirror image of the template surface having a wood grain surface with at least one knot.

19. The method of claim 18, further comprising fashioning the template.

20. The method of claim 17, wherein the composite structure of predetermined shape comprises a skin sheet.

21. The method of claim 20, wherein the skin sheet comprises multiple layers.

22. The method of claim 20, wherein the skin sheet comprises a gel coat material as the outer layer.

23. The method of claim 22, wherein the gel coat used for the outer layer is substantially transparent.

24. The method of claim 20, wherein the skin sheet comprises a pigmented layer.

25. The method of claim 23, comprising curing the outer gel coat layer on the mold surface and applying a pigmented subsurface layer to the cured gel coat layer and curing the subsurface layer to generate a cured skin sheet having a first layer of substantially transparent gel coat adjacent to the mold and a second pigmented subsurface layer.

26. The method of claim 20, wherein the skin sheet comprises a fiber-reinforced polymer resin.

27. The method of claim 25, further comprising applying a structural support layer comprising a fiber-reinforced resin to the subsurface layer and curing the structural support layer to generate a cured skin sheet having a first layer of substantially transparent gel coat adjacent to the mold, a second pigmented subsurface layer, and a third structural support layer.

28. The method of claim 20, wherein the skin sheet comprises a polyurethane resin.

29. The method of claim 17, wherein at least one knot on the surface of the composite structure of predetermined shape is modified from its original appearance by coloring an area of the surface of the composite structure comprising the knot.

30. The method of claim 29, wherein the knot is modified by coloring the area comprising the knot using an air brush.

31. The method of claim 17, further comprising coloring the surface of the composite structure with at least one pigmented stain.

32. The method of claim 17, further comprising applying the composite structure of predetermined shape to a support structure to provide an outer surface molded to replicate a wood grain surface comprising at least one knot.

33. The method of claim 32, further comprising creating a cavity defined by the composite structure and the support structure and filling the cavity with a self-foaming resin.

34. A method for making a composite door imitating a knotty wood appearance comprising:
(a) identifying at least one template comprising a wooden panel having a wood grain surface with at least one knot;
(b) making a mold using the template such that one surface of the mold comprises substantially a mirror image of the wood grain of the template;
(c) forming a skin sheet on the surface of the mold by (i) applying a polymer resin comprising a transparent gel coat material to the surface of the mold and curing the resin on the surface of the mold; (ii) applying a pigmented subsurface layer to the cured gel coat layer and curing the subsurface layer to generate a skin sheet having a first layer of transparent gel coat and a second pigmented subsurface layer; (iii) applying a structural support layer to the cured pigmented subsurface layer and curing the structural support layer to generate a skin sheet having a first layer of transparent gel coat, a second pigmented subsurface layer, and a third structural support layer, wherein the first layer comprises a surface molded to replicate a wood grain surface comprising at least one knot; and
(d) adhering two of the skin sheets to a frame such that the surface of the skin sheet that was adjacent to the mold is positioned as the outer surface to comprise a surface molded to replicate the shape of a wood grain surface comprising at least one knot.

35. The method of claim 34, wherein the structural support layer of the skin sheet comprises a fiber-reinforced synthetic resin.

36. The method of claim 34, further comprising adhering the skin sheets to a frame so as to create a cavity defined by the skin sheets and the frame and filling the cavity with a self-foaming resin.

37. The method of claim 34, further comprising airbrushing selected portions of the skin sheet to modify the appearance of the wood grain on the skin sheet.

38. A composite door comprising a skin sheet imitating a knotty wood appearance applied to a frame support, wherein the skin sheet comprises an outer surface molded to replicate a wood grain surface comprising at least one knot.

39. The door of claim 38, wherein at least one knot on the surface of the skin sheet is modified from its original appearance by coloring an area of the skin sheet comprising the knot.

40. The door of claim 39, wherein the knot is modified by coloring the area comprising the knot using an air brush.
